(19) United States
(12) Patent Application Publication
(10) Pub. No.: US 2002/0066254 A1
(43) Pub. Date: Jun. 6, 2002

(54) Reinforced formed part, process for its production and its use

(76) Inventor: Alfred Ebbinghaus, Aalen (DE)

Correspondence Address: Gregory P. LaPointe, Bachman & LaPointe, P.C., 900 Chapel Street, Suite 1201, New Haven, CT, 06510-2802, US

(21) Appl. No.: 10/057,546

(22) Filed: Jan. 25, 2002

Related U.S. Application Data
(62) Division of application No. 09/548,559, filed on Apr. 13, 2000.
Application No. 09/548,559 is a continuation-in-part of application No. 09/029,729, filed on Jun. 10, 1998, now abandoned.

(30) Foreign Application Priority Data
Sep. 4, 1995 (DE) 295 14 164.6

(51) Int. Cl. B65D 1/00; F16L 1/00; B32B 1/08; B29D 22/00; B29D 23/00

(52) U.S. Cl. 52/735.1; 428/36.5; 52/309.8

(57) ABSTRACT

The invention relates to a reinforced formed part with longitudinal and/or transverse cross-sections which may differ in shape and/or size, with a hollow outer formed part (12) and a highly deformation-resistant open or closed-cell foam filling (14) which is at least partly adjacent to the outer formed part, at least partly fills the inner space in the hollow outer formed part (12) and improves the mechanical deformation resistance of the outer formed part, and a process for producing the formed part, in which a hollow component is made by a prior art process and a foam is introduced into it in such a way that the foam is at least partly in contact with the hollow component and is a snug fit therein or is secured by a prior art securing process, and the use of the formed part as claimed in one of the preceding claims as a bearing component in scaffolding, in frameworks, especially in the building trade, in vehicle manufacture for air, land and waterborne vehicles and the furniture industry.

The invention relates to reinforced formed parts, processes for their production and to their use. It relates in particular, to formed parts which are at least in part hollow, with longitudinal and/or cross-sections which are different in form and/or size, as necessary, having a hollow external form and a filling of open or closed cell foam.

Supporting elements made from hollow material, such as tubes, rods, hollow supports (e.g. supporting parts for bicycles, car rear axles, exhaust pipes etc., produced by the internal high pressure forming process) are known for a wide variety of applications—for example, for building constructions, in particular bridges and/or houses—as supporting and bearing elements or also for the construction of air, land and water craft, shelving systems, furniture etc.

Inter alia, they have the advantage that they enable the design to be light and elastic but resistant to loads similar to hollow parts with a greater wall thickness or solid parts. They are especially resistant to buckling compared to hollow parts without a filling.

For example, in the case of motor vehicles, cold formed framework structures have recently been used again to save weight, in order to provide a structure that is particularly light, resistant and torsionally rigid. Even in aircraft, where saving weight is an essential aspect of construction, a framework frame with hollow or solid framework bearing parts is useful.

The known bearing structures and elements are still capable of improvement because it is always desirable to make them even more resistant—in particular with improved burst strength and with a better mechanical performance.

It was also disadvantageous that very thick walls and large dimensions always had to be used for supporting hollow parts, which resulted in the part being undesirably heavy and having large dimensions—especially if increased burst strength and/or load bearing capacity and buckling resistance was desired. Where walls were thick, problems also occurred in the production of complicated forms, because the straight-forward forming processes, which could hardly be applied to low-strength materials, could no longer be used.

The foam filling of hollow parts with polymer foams, for example in order to change their vibration characteristics, is already known For example, cardan shafts are foam filled in order to improve their running, and vibration characteristics. Where hollow parts are force fitted in this way, the polymer foam, which, in this case, is not highly resistant to deformation, contributes nothing to the deformation or buckling properties of the shaft and merely acts as a vibration-modifying addition.

The use of metal foams of high deformation strength as impact protection for vehicle trim is known from DE-GM 94 02 743 where a metal foam is used as a deformation cushion. Metal foams with high deformation strength are per se inelastic and deform plastically, whereas elastic parts deform elastically and accomodate shape changes caused by elastic deformation. In this prior art the metal foam alone acts as an energy-dissipating part, i.e. as a “cushion” of a deformation part. We are not talking of a supporting part, but of a deformation part, where the foam itself is not a reinforcement for the external parts or any supporting part.

From U.S. Pat. No. 3,275,424, open cell metal foams, which are produced in hollow external parts, are known to be used as filters—here we are dealing with the special case of a filter and in no way with a supporting part. Filters are inelastic parts with open cells.

Allan et al disclose in U.S. Pat. No. 3,087,807 a method to produce metal foams as such by extrusion—but is not able to produce a foam within an outer body.

Further from U.S. Pat. No. 5,277,469 (KLIPPEL) a hollow reinforcement tube with high strength, toughness and resilience for use as an absorption element in a motor vehicle door is known, which comprises a cold pressed steel profile which is filled with a polymer medium with low specific density or with a metal foam. There is no information contained in U.S. Pat. No. 5,277,496 (KLIPPEL) about the kind of metal foam used—elastic or inelastic foam and how the hollow reinforcement tube can be filled with a metal foam. Filling means, that the foam material is first foamed and then filled as ready foam into the hollow outer part to form the reinforcement tube. Contrary thereto, the inventive part is produced such that the foam itself is foamed within the hollow outer part—there is no filling of a ready-made foam, but the production of the foam within the hollow part—so the inventive part is produced/foamed with an elastic metal foam and not filled with metal foam.

By the foaming of the metal foam a complete form-fit and also force-fit of the reinforcement foam with the outer part can be obtained, in a preferred embodiment of the invention there is forming of an alloy between the hot foamed metal and the outer metal part, so that there is a chemical bonding by formation of an alloy between the metal foam material and the material of an inner region of the outer hollow part So further to the form-fit and force-fit a bonding takes place between the foam and the hollow part in a preferred embodiment, ensuring a still better reinforcement of the outer part.

Contrary thereto KLIPPEL gives no disclosure for the expert how to select the metal foam and how the outer tubular part is filled and how the filling is kept within the outer part.

Typical metal foams according to the invention preferably have a density of more than about 0,3 g/cm³, typically of about 0,6 g/cm³ and an elasticity in the order of 5-40 GPa, which is in the range of the desired elasticity of metal.

Elastic foams in the context of this application means foams of an elasticity of between 1-40 GPa, preferably between 5-26 GPa with a density of between 0.3-5 g/cm³ Densities between 0.3- about 3 g/cm³ are typical for such Aluminum and Zinc alloy foams. When using other metal foams, other densities may apply, as it is obvious to the expert.

Suitable metal external parts have an elasticity of between 60-230 GPa, preferably between 70-220 GPa and especially preferred between 100-210 GPa

The invention does not just use a cold formed outer part with just a metal foam filling, but this metal foam is carefully selected to:

1) have elastic properties similar to the outer formed part

2) adhere or fit itself to the outer formed part without using a brazing material, adhesive or the like (in a preferred form the inner foam really fuses to the outer part in a small connecting zone when foaming the inner material due to the heat exerted during the foaming process step).

The such produced part has unexpected enhancement of load bearing capacity due to the strong bond of the inner and outer materials. The elastic properties of the ready part are much better than of any known parts as vibrations experienced by the ready part are transmitted easily via the strong contact or bond between the outer and inner materials. As no soldering material or adhesive is used, there is no failure of the part due to soldering or adhering mistakes or uneven connecting forces- It was quite unexpected that the selection of special foam material which fixes itself to the outer part without adhesive would produce such a part with drastically enhanced load bearing capacity and elasticity, which can be used in applications in which the part experiences changing loads.

All parts of the state of the art are not able to withstand such changing loads in use E.g. the KLIPPEL invention is relating just to a part that can be deformed only once in an accident (door). KLIPPEL is not able to withstand varying loads nor me other parts.

The state of the art has not taken into account that supporting elements should also be able to withstand vibrations and impact. This is only possible by preparing elastic parts, that are, able to withstand stress by elastic response.

It is the problem of the invention to produce light-weight elastic parts with similar elastic properties as solid metal parts which are lighter and have the sane or better load bearing and buckleproof properties and impact resistance, than known individual parts

The problem Is solved according to the invention by a reinforced formed elastic part with longitudinal and/or cross-sections of different shape and/or size, as necessary, having a hollow external formed part and a foam filling of open or closed cell foam being highly resistant to deformation and being in contact, at least in part, with the external formed part, at least partially filling the internal cavity of the hollow external formed part and improving the mechanical resistance to deformation of the external formed part as depicted in the claims.

Beneficial further developments ensue from the subclaims.

Typical materials for the elastic foams are selected from the group consisting of elastic metal foams of aluminum and it alloys and zinc, and it's alloys with an elasticity module between 5-30 CPa, preferably between 5-25 GPa (For comparison: Foamed Polyurethane typically has an elasticity module of 0,38 at a density of 0.53 g/cm³ and such is unable to provide the necessary strength or bearing capacity for the final reinforced hollow part).

Information about metallic foams having suitable properties may be found in Cellular Solids' Structure and Properties, 1^{st} edition and also 2^{nd} edition, by Loma J. Gibson and Michael F. Ashby, Cambridge University press, 2000. Further reference is made to Journal of Materials Science 18 (1983), 1988-1911 G. J. Davies, Shu Zhen “Metallic foams: their production, properties and applications”, both of which are incorporated by reference.

It is especially preferred that those foams are produced powder-metallurgically—foams made by casting are less favorable, as they normally do have a lower elasticity.

Hollow formed parts are known per se, such as seamless or welded tubes or other known profiles may be used as the hollow external formed part. However, it is also possible to produce such formed parts specially and to design them according to requirements.

Materials available for the hollow parts include metals, but also plastics, including ceramics and glass. It is particularly beneficial if, for example, hollow parts of special shape, which are particularly resistant to burst, such as longitudinally corrugated hollow tubes, bent tubes or the like, are reinforced.

In this case, it is beneficial, for reasons of strength, if the fiber flow of the material of the external form essentially runs parallel to the external contours of the formed part, as is possible, for example, by manufacturing the external formed part using the known internal high pressure forming process. This means that the appropriate cold forming materials are known to the expert.

It can also be beneficial for the external formed part to have several tiered layers running parallel to each other, of the same or different materials, the fiber flows of which run, at least in part, parallel to each other.

To save weight in particular, the entire part may be made essentially from the same or different light metals. For example, the light metal can be aluminum, magnesium, zinc or an alloy of the aforesaid metals which is also associated with good corrosion resistance.

It is possible and for many applications desirable, that the part comprises fiber-reinforced materials, which are lightweight and possess a good mechanical load-bearing capacity.

Naturally, materials can also be used for the external formed part which have been hot formed in known manner, for example hot formed plastics, such as blown or cast plastics, including fiber-reinforced plastics, which gain considerable bearing strength as a result of the internal foam. One particular application is glass, which is very elastic and light and is available as foam.

The part can have different longitudinal sections and so different cross-sections.

It may be beneficial, for the individual parts of the foam filled formed part to be made from different materials, such as metal/ceramic; metal foam/plastic outer wall,, including natural polymers, such as paper or cellulose or plastics etc.

It may be useful for at least one hollow external section to have depressions or protrusions.

The problem is also solved by a process for manufacturing a formed part, where a hollow part is produced by a forming process as known per se, and then a prepreg body that can foam when heated is introduced into this hollow part in such a way that the foam body at least partially rests against the hollow part and is attached within the hollow part by a form fit or by formation of an alloy with the outer part's material.

Suitable processes for the preparation of typical foamable aluminum-comprising materials useful as prepregs to be foamed by heat exposure are disclosed in U.S. Pat. No. 5,393,485 to WÖRZ et al., the information contained therein is incorporated herein by reference. Such lightweight preprepared foamable material can be used to be put inside the hollow part and to be foamed afterwards by application of heat above 300° C.—depending on the foam produced.

To production hollow formed parts, a hollow external form is produced in the known way by drawing, casting, extruding or internal high pressure forming and then filled with the foam starting material. The hollow external part can be made, at least in part, of metal, which is produced by an internal high pressure forming process and in which the foam material is subsequently expanded.

However, it is also possible to fill a mold with the elastic metal foam separately and then introduce it into the external formed part and fixing it thereto by form fit by a shrink process or by drawing in said formed part into the external formed part. Care must be taken here to ensure that the materials do not become separated under the anticipated operating conditions.

The production of metal foams has become possible recently, where, for example, a propellant/metal mixture is expanded in the hollow external form in a manner known per se (vide U.S. Pat. No. 3,087,807 to Allen et. al)

A steel, zinc or aluminum foam for example, may be selected as metal foam or any other foam may be chosen based on the requirements and intended use and corresponding properties of the hollow part,

For example, the foam filling can have the main purpose of vibration attenuation or corrosion prevention in the cavity.

It is advantageous for the foam filling to be an elastic metal foam, if for example, it is to be exposed to high temperatures or if it is to support/stabilize the external formed part. Filling the external formed part with foam also improves the elastic characteristics of the external walls as well as the thermal and acoustic insulation. However a ready-made elastic metal foam body can be introduced into a hollow external part and gluing in place/soldering or fixing by drawing in the external part around the foam body, can then be carried out.

The foam can also be of the open cell type, thus enabling, for example, fluids to pass through, in order to cool or heat the formed part.

A preferred embodiment of the production process for parts, comprises the following steps:

Provision of a hollow profile, optimally with varying diameters;

Insertion of a section of a hollow profile into a mold with an enlargement in the forming area;

Application of an internal high pressure to the tube, so that the wall of the tube is expanded in the enlarged area, of the mold;

Removal of the formed hollow section with expansions and, introduction of a foam starting mixture comprising foamable metal particle material and propellant into the hollow part and activation of the propellant, so that the foam fills the hollow part.

However, it is also possible to produce the foam separately from the hollow part in a foaming mold and then attach the spongy structure to the hollow external part for example, by a shrink process or by drawing in the external part, or to introduce it following thermal expansion of the hollow section, where attachment then takes place by shrinking the external part when cooling.

The internal high pressure process mentioned, also known as the IHP process or “Hydroforming” is in this case, the process that has been described, for example, in the Industrial Gazette [Industrieanzeiger] No. 20 of 9.3.1984 and also in “Metallumformtechnik” [Metal forming technology], Edition ID/91, page 15 ff-A. Ebbinghaus: “Präzisionswerksücke in Leidhtbuweise, hergestellt durch Innenhochdruckumformen” [precision workpieces of light construction, produced by internal high pressure forming]” or also in “Werkstoff und Betrieb” [Material and operation] 123 (1990), 3, page 241 to 243: A. Ebbinghaus: “Wirtschaftliches Konstruieren mit innenhochdruckumgeformten Präzisionswerkstücken” [Economic construction with internal high pressure formed precision workpieces]” and also in “Werkstoff und Betrieb” 122, (1991), 11 (1989), pages 933 to 938. In order to avoid repetition, reference is made to their full disclosure. This process was only used hitherto, to production different formed hollow parts, such as for the production of built camshafts to attach cams to a tube, to production hollow camshafts and also to production motor vehicle frame parts.

Surprisingly, this internal high pressure process makes it possible to form completely lightweight hollow metal parts, where the fiber flow in the area of the intersection and of the walls, runs essentially parallel to the external contour, without there being any burst or other weaknesses. These hollow formed parts can therefore be developed in a lighter form than hitherto, by virtue of the high wall strength produced by the favorable fiber flow and the reinforcement provided by the internal foam filling, thus making possible considerable savings in weight. It is also possible to use laminated materials for the external form, provided they can be formed together. By selecting suitable materials, laminates can be lighter than solid materials and also have the advantage of attenuating vibrations and also comprising on the surfaces, in keeping with the ambient stresses (i.e. corrosion by acids etc.) or for aesthetic reasons (color) other layers, so that such a part has additional beneficial vibration damping characteristics, because the foam filling makes elastic contact with the external walls, depending on the material—in other words, the materials are affected less by vibrations.

A multi-layer metal tube can also be selected as the starting part, depending on the requirements for the material.

Multi-layered embodiments have the advantage that the surfaces of the hollow part can withstand different stresses and also have the advantage that they are poor conductors of all types of vibrations, which decisively improves the vibration characteristics of the hollow part in use The inner layer can then be selected in such a way that under predetermined conditions, for example, raised temperature, a connection is made to the foam material, similar to a soldering process or by mutual diffusion, thus effecting the attachment of the foam to the hollow external part.

However, it is also possible, to provide an elastic metal foam in a plastic external hollow section or in a multi-layer outer hollow section having a plastic outer layer, particularly if the plastic outer layer is required for corrosion or other reasons, for example, the lubrication properties of the plastic etc.

It is also possible to form the entire formed part after introducing the foam, using a forming process and thus obtain other forms where open cell foams must be used if an internal high pressure forming process is used.

Beneficial uses of the part according to the invention include land, air and water vehicles, bicycle, motor cycle and car frames, building and civil engineering, scaffolding, shelving systems and furniture, and, in particular, uses as cooling parts where cooling fluids can be conveyed through their open cell foam.

It can, in particular, be used in all areas of light-weight construction

Because essentially closed, elastic hollow parts filled with elastic metal foam according to the invention, are used as structural parts, this enables extremely light but strong, vibration-attenuated parts to be used, or even structural parts of smaller dimensions.

The fact that an internal high pressure forming process is used, makes it possible to produce protrusions, impressions, and similar on the external hollow part in one forming process. This makes it possible to reduce subsequent treatment steps.

Very different hollow profiles, such as corrugated tubes etc., can be used as hollow parts, rectangular profiles, angle profiles, tubes.

Hence, a part is created that has a lower weight compared with parts hitherto, whilst having the same or even improved load bearing capacity and light weight, which can be productioned with a high degree of production precision and with a lower scrap rate.

The invention is explained in greater detail below on the basis of the enclosed drawing, in which preferred, but in no way exclusive, embodiments of the invention, shown.

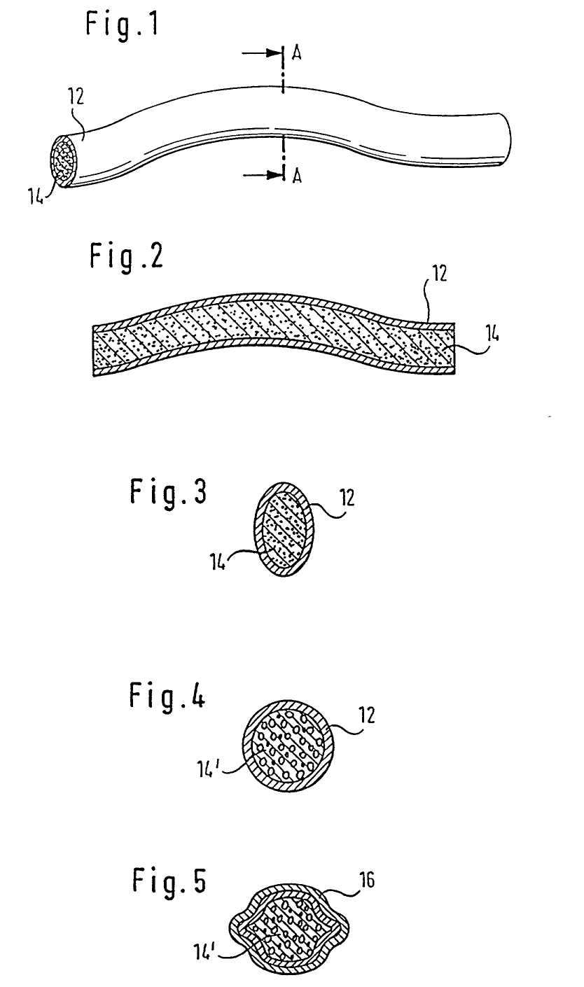

FIG. 1 shows a cut-out section of a part according to the invention in perspective, with a closed cell foam.

FIG. 2 shows the part according to FIG. 1 in longitudinal section.

FIG. 3 shows the part according to FIG. I in cross-section along the line A-A of FIG. 1.

FIG. 4 shows a part according to the invention with open cell foam in cross-section.

FIG. 5 shows a cross-section through a part according to the invention with multi-layer external walls and

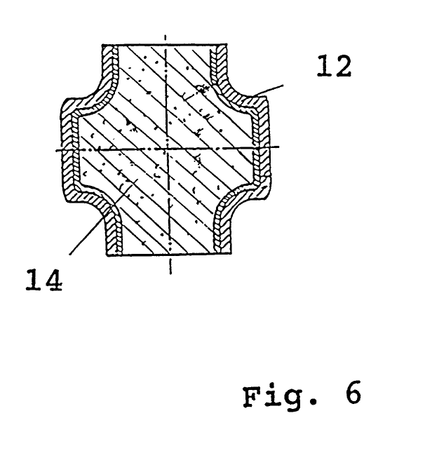

FIG. 6 shows a longitudinal section through a section of a multi-layer, foam-filled hollow part with various cross-sections.

It can be seen from FIGS. 1, 2 and 3, each of which shows the same support part, the part depicted therein comprises an external wall 12 of steel with an elasticity module of 210 GPa and the aluminum foam filling with an elasticity module of 60 GPa. The external formed part was three-dimensionally formed by Hydroforming so that it can be used, for example, as part of a 3-dimensional suspension axle.

It should be noted that desired crumple zones can be designed into the parts—the external wall—produced by the forming process, by specifically molded grooves for example, so that when vehicles are involved in an accident, energy is absorbed by specific deformation—or reinforcement profiles can even be incorporated—for example, by forming out longitudinal ribs (passenger cell).

In this case, the hollow profiles of the framework can have different diameters over their length, as well as different cross-sections.

FIG. 4 shows details of another form of application of an elastic part according to the invention. In this case, it is a supporting part for motor vehicle catalytic converters which has an open cell steel foam in a steel outer casing In this example, the generally known problems of these supporting parts, of the connection between casing and supporting part and the problem of producing gas ducts, which are then coated with the catalyst, are fully eradicated, on account of the fact that now, for the first time, the same material can be used for casing and gas emission body (also often referred to as honeycomb) and that tensions in the catalyst supporting part are avoided because of the different coefficients of expansion of the materials used for the supporting part, which hitherto limited its useful fife.

FIG. 5 shows a further embodiment of a part according to the invention, having a ribbed tube, where the multi-wall external form has a foam filling.

The hollow profiles may comprise either a single material, for example, steel, or a light metal alloy, but, according to the process used, it is also possible to form laminate material and even plastic-coated or overlaid tubes, depending on the use intended.

By providing the appropriate layers it is possible to achieve corrosion resistance and also color, without the need for further process stages.

Foam fillings with closed cell foams in particular, are able to produce great corrosion resistance, because no corrosive material can penetrate the closed cell foam.

As is known, by adding material along the longitudinal axes of the tube during forming, for example by moving form elements, an essentially uniform wall thickness can be achieved in the external form, with the result that weaknesses in the wall thickness of the external form can be, at least partially, compensated for by the forming of protrusions, resulting in the formation of protrusions without weakness.

An embodiment of this type is shown in FIG. 6, where a multi-layer external formed part 12, the outer layer thereof is made from steel and the inner layer of an elastic aluminum alloy, has a flange-like boss and is filled with aluminum foam 14.

This formed part in FIG. 6 can, of course, also have different combinations of material.

Hence the development according to the invention, creates a more resistant, and lighter supporting material than has been possible up to now.

Further embodiments and developments are, as part of the scope of protection of the claims, known to the expert and the extent of protection is in no way limited to the embodiments listed as examples, which are only intended by way of explanation.

1. A reinforced formed part comprising
a hollow outer formed part and a metal foam filling located within said hollow outer formed, which is made at least partially of metal and a metal foam filling located within said hollow external formed part such that said metal foam filling at least partially contacts and fills said hollow external formed part so as to ameliorate the elastic properties of the external formed part as well as is load bearing capacity and resistance to deformation, said metal foam filling having a structure having high resistance to deformation, said reinforced formed part being formed by the following steps;
producing a hollow external formed part
providing a metal cellular foam material within said hollow external formed part; and
simultaneously therewith fixing said cellular metal foam material to at least a part of the hollow external formed part, so that at least part of the foam rests against the external formed part and is connected thereto, at least by being in contact with it and that ist mechanical resistance to deformation is improved.

2. A reinforced part according to claim 1 wherein the hollow external part is produced by an internal high pressure forming process and is then filled with a foam material.

3. A reinforced part according to claim 1 wherein the hollow external formed part is made in part of a polymer, where the external formed part is produced by forming at least a single-layer material by a process selected from the group consisting of casting, thermal forming, blowing and internal high pressure forming, and is then filled with a foam material.

4. A reinforced part according to claim 1 wherein the external formed part further comprises at least one tiered layer running parallel thereto.

5. A reinforced part according to claim 1 wherein the external formed part comprises several tiered layers running parallel to each other, made from different material.

6. A reinforced part according to claim 1 wherein the hollow external formed part is formed by cold forming a material selected from the group consisting of metal, light metal, steel, aluminum, zinc, magnesium, titanium, and alloys thereof.

7. A reinforced part according to claim 1 wherein the external formed part has fiber reinforced materials.

8. A reinforced part according to claim 1 wherein the metal foam is selected from the group consisting of steel, aluminum, and alloys thereof.

9. Process for the production of a formed part according to any of the preceding claims, characterized in that a hollow external formed part is produced by a cold forming process as known per se, and that a foam is prepared within this hollow external formed part by inserting a foamable prefoam part and heating this arrangement to a temperature above about 300 deg C., so that the foamable part expands to form a metal foam that fills at least partially the hollow of the outer part in such a way that the foam body, at least partially rests against the hollow part and is attached within the hollow part by a snug fit.

10. Process according to claim 9, characterized in that the hollow external formed part is, at least, partly made up of metal and is produced by an internal high pressure forming process, and subsequently foamed out by a foamable material.

11. Process according to claim 9, characterized in that the hollow external formed part is made up, at least in part, of a polymer, where the external formed part is produced by forming its at least single-layer material, by a forming process as known per se, such as casting, thermal forming, blowing and internal high pressure forming and is subsequently foamed with a foam material.

12. Process according to any of the claims 9 to 11, characterized in that when foaming the metal foam in the external formed part an alloy is formed at the boundary between the outer coldformed part and the foam, thus attaching the foam to the outer part.

13. Process according to any of the claims 9 to 12, characterized in that after producing the foam in the external formed part, the foam located in the external formed part and the hollow external formed part are jointly formed.

14. Reinforced formed part according to claim 1, characterized therein, that it is a supporting part in scaffolding, frameworks or in construction, in vehicle building for air, land and water craft and furniture.
